(19) United States
(12) Patent Application Publication
(10) Pub. No.: US 2014/0263283 A1
(43) Pub. Date: Sep. 18, 2014

(54) SYSTEMS AND METHODS FOR HEATING A THERMOPLASTIC PRODUCT

(71) Applicants: Brent C. Maxwell, West Valley City, UT (US); Michael P. Guymon, Ogden, UT (US); Jared S. Pringle, West Haven, UT (US)

(72) Inventors: Brent C. Maxwell, West Valley City, UT (US); Michael P. Guymon, Ogden, UT (US); Jared S. Pringle, West Haven, UT (US)

(21) Appl. No.: 14/214,239

(22) Filed: Mar. 14, 2014

Related U.S. Application Data
(60) Provisional application No. 61/800,394, filed on Mar. 15, 2013.

(51) Int. Cl. H05B 6/10; H05B 11/00

(52) U.S. Cl. CPC H05B 6/10; H05B 11/00
USPC 219/601; 219/635; 252/500

(57) ABSTRACT

The present invention relates to thermoplastic products. In particular, the present invention relates to systems and methods for heating a thermoplastic product. While the thermoplastic product can include any suitable ingredient, in some cases, it includes one or more electrically-conductive materials, such as iron. Also, while the thermoplastic product can be melted in any suitable manner, in some cases, an inductive heater is used to heat the electrically-conductive material and thereby melt the thermoplastic product. In some cases, the thermoplastic product is configured to be melted on demand. While this can be accomplished in any suitable manner, in some instances, the thermoplastic product is formed into an elongated shape, such as rope, that is fed past a heater, such as an inductive heater, to melt the product. In other cases, the thermoplastic product is melted in a vat that is heated by an inductive heater. Other implementations are also described.

### CROSS-REFERENCE TO RELATED APPLICATION

This application claims priority to U.S. Provisional Patent Application Ser. No. 61/800,394, filed Mar. 15, 2013, and entitled “SYSTEMS AND METHODS FOR HEATING A THERMOPLASTIC PRODUCT”; the entire disclosure of which is hereby incorporated by reference.

### BACKGROUND OF THE INVENTION

1. Field of the Invention

The present invention relates to thermoplastic products. In particular, the present invention relates to systems and methods for heating a thermoplastic product. In some non-limiting implementations, the described systems and methods use an inductive heater to heat the thermoplastic product. Indeed, in some non-limiting implementations, an elongated piece of thermoplastic product comprising an electrically-conductive material is moved past one or more inductive heaters to change the thermoplastic product to a liquid or semi-liquid state.

2. Background and Related Art

Thermoplastics typically include one or more polymers that change to a liquid or semi-liquid state when the polymers are heated sufficiently, and that solidify to a rigid or semi-rigid state when the polymers are cooled sufficiently. While thermoplastics have a wide variety of uses, in some cases, such materials are used as pavement joint sealants, pavement crack sealants, waterproofing membranes, roofing asphalt, paving grade asphalt cement, and a variety of other products. In many such cases, the thermoplastics (e.g., thermoplastic sealants, thermoplastic coatings, etc.), are heated, mixed, and then applied to a surface (e.g., pavement, a roof, etc.) where they are allowed to cool and harden.

When thermoplastics are used as sealants, membranes, adhesives, and/or in a similar manner, they are often used to minimize water infiltration, prevent accumulation of debris, prolong the life of, and otherwise protect the material or structure to which they are applied. In this regard, some examples of materials that can be protected by thermoplastics (such as thermoplastic sealants) include, but are not limited to, asphalt pavement and Portland cement pavement. Moreover, some non-limiting examples of structures that can be protected by thermoplastics include roads, roofs, bridge decks, retention ponds, etc.

Although thermoplastics can be heated through a number of methods, some such methods may have shortcomings. Indeed, in some methods, blocks of thermoplastic are placed into a caldron that is heated by fire. In some such methods, the thermoplastic blocks can be relatively heavy (e.g., weigh up to 100 pounds or more). As a result, as a user places such blocks into the caldron, the user may inadvertently drop or mishandle the block, which can cause molten thermoplastic to splash out of the caldron and cause serious burns to the user or others.

In another example of a potential shortcoming, some conventional methods for heating thermoplastics may take a relatively long period of time (e.g., several hours) to bring a thermoplastic to a suitable temperature and viscosity. As a result, such methods may be relatively inefficient and costly, especially where one or more workers are waiting to use the liquid thermoplastic.

In yet another example, in some known methods for heating thermoplastics, it may be difficult to heat a small amount of thermoplastic for use in a specific application. Accordingly, in some such methods, a user may need to heat more thermoplastic than is needed for an application. As a result, unnecessary amounts of energy, time, and/or fuel can be wasted on relatively small jobs.

In still another example, under some conventional heating methods, a user must maintain all of the thermoplastic in a caldron at a high temperature for as long as the user plans on applying melted thermoplastic to a surface—even if there are extended periods of time (e.g., a lunch break) when the user does not plan on applying the melted thermoplastic. Accordingly, such methods may be undesirably inefficient.

In even another example of a potential shortcoming of some conventional methods for heating thermoplastics, some such methods use pumps to dispense melted thermoplastic. Accordingly, in order to prevent damage to such pumps, the thermoplastics used in such methods may need to be substantially free from some relatively inexpensive materials (such as ground glass) that are highly abrasive.

Thus, while techniques currently exist that are used to heat thermoplastics, challenges still exist, including those discussed above. Accordingly, it would be an improvement in the art to augment or even replace current techniques with other techniques.

### SUMMARY OF THE INVENTION

The present invention relates to thermoplastic products. In particular, the present invention relates to systems and methods for heating a thermoplastic product. In some non-limiting implementations, the described systems and methods use an inductive heater to heat the thermoplastic product. Indeed, in some non-limiting implementations, an elongated piece of thermoplastic product comprising an electrically-conductive material is moved past one or more inductive heaters to change the thermoplastic product to a liquid or semi-liquid state.

Implementation of the present invention takes place with at least one thermoplastic product. While the thermoplastic product can comprise any suitable ingredient that allows it to be melted when heated and then to solidify when cooled, in some non-limiting implementations, the thermoplastic product comprises an electrically-conductive material, or a material that can be heated when exposed to an inductive heater. Some examples of such electrically-conductive materials include, but are not limited to, magnetic and/or ferromagnetic materials, such as iron, steel, and iron alloys.

While the thermoplastic product can have any suitable shape (e.g., as pellets, powder, blocks, bags, balls, chips, flakes, chunks, etc.), in some non-limiting implementations, the product has an elongated shape. Indeed, in some cases, the thermoplastic product is shaped to resemble a rope, a cord, a stick, a brick, a braid, a bar, a cylinder, or any other suitable elongated shape.

In some non-limiting implementations, the thermoplastic product also comprises an outer layer of a material having a different chemical makeup than the thermoplastic product itself. In some cases, this outer layer helps to prevent the thermoplastic product from unintentionally sticking to itself and/or other surfaces. While this outer layer can comprise any suitable material, in some instances, the outer layer comprises a paper, a polymer (e.g., an expanded polymer, such as polystyrene), a plastic (e.g., a low-density polyethylene, an ethylene-propylene copolymer, an ethylene vinyl acetate, etc.), and/or any other suitable material.

The thermoplastic product can be melted in any suitable manner. In some instances, however, a heating system (such as a thermoplastic-dispensing wand) is configured to force the thermoplastic product (e.g., an elongated piece of the product) past a heater. In such instances, the thermoplastic product can be forced past any suitable heater that is capable of melting the product, including, without limitation, one or more inductive heaters, microwave heaters, heating elements, conduction heaters, infrared radiation heaters, dielectric hysteresis heaters, electric arc heaters, plasma heaters, laser heaters, fire heaters, other heaters, and combinations thereof. Indeed, in some non-limiting implementations, the thermoplastic product (e.g., a thermoplastic product coated with and/or containing an electrically-conductive material) is forced past an inductive heater.

In some other instances, the thermoplastic product is heated in a reservoir. In such instances, the reservoir can be heated in any suitable manner. For instance, the reservoir can be heated (directly and/or indirectly) by one or more heaters, including those previously listed. Indeed, while in some non-limiting implementations, the reservoir is heated by an inductive heater, in other non-limiting implementations, the reservoir is heated by fire (e.g., directly or indirectly through a heat transfer fluid (e.g., oil or another transfer fluid) that is heated by the fire) and an inductive heater.

In still other instances, the thermoplastic product is melted through the use of an intensive kneader (e.g., an internal batch mixer, such as a BANBURY® mixer) that is capable of using friction and/or pressure to melt the product. While such a mixer can be used to melt thermoplastic product that comprises an electrically-conductive material, in some embodiments, such a mixer is used to melt thermoplastic product that is free from an electrically-conductive material.

While the described systems and methods can be particularly useful in the areas of sealants (e.g., as pavement crack sealants, joint sealants, roofing sealants, and other sealants) the described systems and methods can also be used in a variety of different applications and in a variety of different areas of manufacture to yield a thermoplastic product for use or application to a surface. Some examples of such uses and applications include using the described thermoplastic products and/or systems and methods in pavement maintenance (e.g., for asphalt crack sealants, concrete joint sealants, bridge expansion joint sealants, wide crack sealants, pothole patching products, concrete spall repair products, concrete patching products, paving joint adhesives, traffic loop detector sealants, pavement marker adhesives, colored sealants and products, hot applied rubberized chip seal binders, chip seal binder additives, hot applied seal coats, etc.), roofing (e.g., for shingle tab adhesives, polymer roofing asphalts, polymer modified bitumens, vertical surface adhesives, vertical surface repairs, perforation repairs, etc.), paving (e.g., for paving grade asphalt cements, polymer modified paving asphalt cements, paving additives and modifiers, etc.), gaskets, thermoplastic paints, thermoplastic sealants, silicon sealants, asphalt, sealants, caulking, hot melt adhesives, hot glue applications (e.g., for crafts, packaging, containers, construction, etc.), extruded rubber products, pre-weighed polymers, and/or any other suitable product or process that allows for the use of a thermoplastic product (e.g., a thermoplastic product comprising an electrically-conductive material).

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention in any manner, the present invention will be described and explained with additional specificity and detail through the use of the accompanying drawings in which:

FIG. 1A illustrates a perspective view of a representative embodiment of a thermoplastic product;

FIG. 1B illustrates a cross-sectional view of a representative embodiment of the thermoplastic product, wherein an elongated electrically-conductive material runs within the thermoplastic product;

FIGS. 1C-1D each illustrate a schematic view of a representative embodiment of the thermoplastic product, wherein several electrically-conductive wires run through a length of the thermoplastic product;

FIG. 1E illustrates an elevation view of a representative embodiment of the thermoplastic product, wherein an electrically-conductive material is disposed on an outer surface of the thermoplastic product;

FIG. 2 illustrates a perspective view of a representative embodiment in which the thermoplastic product is coiled around a spool;

FIG. 3 illustrates a perspective view of a representative embodiment of the thermoplastic product including an outer layer;

FIG. 4 illustrates a cross-sectional view of a representative embodiment of the thermoplastic product, wherein beads of the thermoplastic product are disposed within the outer layer;

FIG. 5A illustrates a schematic view of a representative embodiment of a system for heating the thermoplastic product;

FIG. 5B illustrates a schematic view of a representative embodiment of a heater configured to heat the thermoplastic product;

FIG. 6 illustrates a cross-sectional view of a representative embodiment of a thermoplastic-dispensing wand that is configured to heat the thermoplastic product; and

FIGS. 7-10 each illustrate a cross-sectional view of a different representative embodiment of a heating system for the thermoplastic product.

### DETAILED DESCRIPTION OF THE INVENTION

The present invention relates to thermoplastic products. In particular, the present invention relates to systems and methods for heating a thermoplastic product. In some non-limiting implementations, the described systems and methods use an inductive heater to heat the thermoplastic product. Indeed, in some non-limiting implementations, an elongated piece of thermoplastic product comprising an electrically-conductive material is moved past one or more inductive heaters to change the thermoplastic product to a liquid or semi-liquid state. To provide a better understanding of the described systems and methods, a more-detailed description of the thermoplastic product is discussed below, followed by a discussion of systems and methods for heating the thermoplastic product.

With reference now to the thermoplastic product, this product can comprise virtually any suitable thermoplastic product that can be melted and solidified. Some non-limiting examples of such products include sealants (e.g., pavement crack sealants, joint sealants, wide crack sealants, pavement joint sealants, asphalt sealants, concrete sealants, bridge expansion joint sealants, gap sealants, mastics, waterproofing sealants, colored sealants, and other sealants), paving grade asphalt cements, hot melt adhesives, hot glues, thermoplastic adhesives, pavement maintenance materials (e.g., pothole patching products, concrete spall repair products, concrete patching products, paving joint adhesives, colored products, chip seal binder additives, hot applied seal coats, etc.), roofing (e.g., roofing asphalts, shingle tab adhesives, shingle lamination adhesives, polymer asphalts, polymer modified bitumens, ice and snow shields, vertical surface adhesives, vertical surface repair, perforation repair, etc.), paving materials (e.g., paving grade asphalt cements, polymer modified paving asphalt cements, paving additives and modifiers, etc.), thermoplastic paints, thermoplastic caulking, asphalt sealants, cement sealants, extruded rubber products, pre-weighed polymers, and/or virtually any other suitable product containing a thermoplastic product. Indeed, in some embodiments, the thermoplastic product comprises a sealant.

The thermoplastic product can comprise any suitable ingredient or ingredients that allow it to be heated from a solid state to a liquid or semi-liquid state and then to solidify when cooled. Some non-limiting examples of suitable ingredients include one or more of the following: thermoplastic materials (e.g., rubber and/or plastic thermoplastic elastomers, polybutadienes, styrene butadiene styrene block copolymers, styrene isobutyl butadiene copolymer, styrene ethylene butadiene styrene, hydrogenated styrene butadiene styrene, styrene butadiene rubber, nitrile rubber, ethylene butadiene styrene, ethylene vinyl acetate, synthetic latex, latex, natural rubber, olefins, polyolefins, amorphous polyolefin, polyamide, polyethylene, high density polyethylene, low density polyethylene, linear low density polyethylene, polypropylene, polyester, high density polypropylene, low density polypropylene, ethylene propylene copolymer, polystyrene, high density polystyrene, low density polystyrene, high impact polystyrene, thermoplastic polyurethane, polyurethane, polybutene, polybutylene, polyisobutylene, silicon rubber, polypyrrole, asphalt, asphalt cement, roofing asphalt, light oils, vacuum gas oils, ground tire rubber, one or more oils, one or more polymers, styrene butadiene styrene block copolymers, styrene isoprene styrene, styrene ethylene/butylene styrene, styrene ethylene/propylene, ethylene propylene copolymers, polyvinyl chloride, polytetrafluoroethylene, polycaprolactone with soy protein, polycarbonate, silicon, tar, Trinidad lake asphalt, Great Salt Lake oil, polymer materials, graphite, and/or any other materials exhibiting thermoplastic characteristics (either alone or when mixed with other materials)); tackifying resins (e.g., rosins and their derivatives, terpenes and modified termines, aliphatic cycloaliphatic and aromatic resins, hydrogenated hydrocarbon resins, terpene-phenol resins, etc.); waxes (microcrystalline waxes, fatty amide waxes, oxidized Fischer-Tropsch waxes, etc.); plasticizers; antioxidants; pigments; UV stabilizers; fluoropolymers; perlite microspheres; ceramic microspheres; talc; glass (e.g., ground glass); cement; kaolin; limestone; sodium bentonite; sulfur; mineral fillers; aggregates; fibers; tar sands; plasticizers; anti-strip agents; polyester fibers; light weight aggregates; calcium oxide; magnesium oxide; titanium dioxide; aluminum (e.g., aluminum metal flake); carbon; eggshells; incinerator ash; metalcines; syndiotactic polystyrene (“SDS”) materials; SPR materials; slag (e.g., slag from mineral refining, slag from iron and steel manufacturing, slag from iron and steel recycling, and/or slag from any other suitable source); and materials that have already been used for an intended purpose (e.g., recycled asphalt shingles, recycled tar paper, recycled asphalt pavement, packaging materials, etc.); other materials; and/or any suitable combination thereof.

In some embodiments, the thermoplastic product optionally comprises an electrically-conductive material. In such embodiments, the thermoplastic product can comprise any electrically-conductive material that allows the thermoplastic product to be inductively heated (including, without limitation, via an electromagnet or other inductive heater that causes eddy currents (or Foucault currents) to be generated in the material and allows the resistance of the material and/or magnetic hysteresis losses to lead to heating (e.g., Joule heating) of the material). Some examples of suitable electrically-conductive materials include, but are not limited to, iron, iron oxides, iron alloys (e.g., magnetite, etc.), carbon steel, stainless steel (e.g., stainless steel 432, stainless steel 304, etc.), slag from mineral refining, slag from iron and steel manufacturing, slag from steel and iron recycling, aluminum alloys, copper alloys, ferromagnetic materials, magnetic materials, graphite, brass, copper, and/or any other suitable material that can be inductively heated. Indeed, in some embodiments, the electrically-conductive material comprises a ferromagnetic material, such as iron or an iron alloy.

Where the thermoplastic product comprises an electrically-conductive material, the electrically-conductive material can be incorporated with the thermoplastic product in any suitable manner, including, without limitation, by being impregnated within, intercalated within, running within, running without, and/or being coated on or otherwise being disposed in and/or on or otherwise being associated with the thermoplastic product such that when the electrically-conductive material is inductively heated, the thermoplastic product softens and/or melts. In some embodiments, however, the electrically-conductive material is impregnated within the thermoplastic product. By way of non-limiting illustration, FIG. 1A shows a representative embodiment in which particles of an electrically-conductive material 15 are interspersed within the thermoplastic product 20. In some other illustration, however, FIGS. 1B through 1E each show a representative embodiment in which the electrically-conductive material 15 comprises one or more wires, rods, tubes, weaves, or other elongated structures 21 that run through and/or across a length of the thermoplastic product,

The electrically-conductive material 15 can be any suitable shape and size that allows it to be inductively heated by an inductive heater and, in turn, to heat and melt surrounding thermoplastic product 20. Indeed, in some embodiments, the electrically-conductive material is present in the shape of particulates (e.g., filings, powder, pellets, spheres, granules, platelets, aggregates, fibers, filaments, flakes, shavings, chips, chunks, beads, etc.), wires, rods, tubes, coils, and/or any other suitable shape.

In some embodiments, the electrically-conductive material 15 (e.g., iron, carbon steel, etc.) has a size (e.g., a particle size) having a length and a width that are each less than a measurement selected from about 2.5 cm, about 1 cm, about 1 mm, about 0.5 mm, and about 0.1 mm. In other embodiments, the electrically-conductive material has a particle size having a length and width that are larger than a measurement selected from about 1 nm, about 1 about 500 μm, about 1 mm, and about 1 cm. In still other embodiments, the electrically-conductive materials have a particle size that falls in any suitable sub-range or combination of the preceding ranges. In still other embodiments, depending on the characteristics of the thermoplastic products and the desired use, the electrically-conductive materials can be any other suitable size.

In some embodiments in which the electrically-conductive material 15 comprises one or more wires, rods, filaments, fibers, tubes, and/or other elongated structures that extend through and/or across a portion of the thermoplastic product 20, the elongated structure can have any suitable thickness (e.g., diameter). Indeed, in some embodiments the elongated electrically-conductive material has a thickness that is less than an amount selected from about 2.5 cm, about 1 cm, about 1 mm, about 0.5 mm, and about 0.1 mm. In other embodiments, the elongated electrically-conductive material has a thickness that is larger than a measurement selected from about 1 nm, about 1 μm, about 500 μm, about 1 mm, and about 1 cm. In still other embodiments, the elongated electrically-conductive material has a thickness that falls in any suitable sub-range or combination of the preceding ranges.

The various ingredients of the described thermoplastic products 20 can be present in the products at any suitable concentration. With reference to the electrically-conductive materials 15 (e.g., iron, carbon steel, slag, graphite, etc.), in some embodiments, the electrically-conductive materials comprise between about 0.01% and about 95%, by weight, of the described thermoplastic products 20. In other embodiments, the electrically-conductive materials comprise between about 0.1% and about 40%, by weight, of the thermoplastic product. In still other embodiments, the electronically-conductive material comprises between about 1% and about 34%, by weight, of the thermoplastic product. In yet other embodiments, the electrically-conductive materials comprise any suitable sub-range of the aforementioned ranges (e.g., between about 5% and about 50%, by weight, of the thermoplastic product).

The remaining ingredients of the thermoplastic product 20 can also be present in any suitable concentration. In one non-limiting example, Table 1 shows some representative weight percentage ranges of ingredients for inclusion into various thermoplastic products of the present invention. As used in this example and throughout this specification, the term raw material, and variations thereof, may refer to various ingredients of a thermoplastic product before such ingredients are heated with other ingredients to form a liquid or semi-liquid phase of the thermoplastic product.

TABLE 1

| | Weight % |
|---|---|
| Raw Material | Range |
| Asphalt Cement | 0-99.9% |
| Light Oils | 0-95% |
| Styrene butadiene Styrene block copolymers | 0-20% |
| Styrene butadiene Rubber | 0-20% |
| Polyolefins | 0-99.9% |
| Ground Tire Rubber | 0-50% |
| Ground Limestone | 0-70% |
| Ground Talc | 0-70% |
| Ground Sodium Bentonite | 0-15% |
| Anti-Strip Agents | 0-2% |
| Plasticizers | 0-5% |
| Roofing Asphalt | 0-99.9% |
| Tar Sands | 0-99.9% |
| Trinidad lake asphalt | 0-99.9% |
| Great Salt Lake oil | 0-70% |
| Polyester fiber | 0-30% |
| Light weight aggregates (specific gravity 1.0 to 2.0 g/ml) | 0-80% |
| Medium light weight aggregates (specific gravity 2.0 to | 0-80% |
| 3.0 g/ml) | |
| Perlite microspheres | 0-80% |
| Calcium Oxide | 0-70% |
| Magnesium Oxide | 0-70% |
| Titanium dioxide | 0-80% |
| Aluminum Metal Flake | 0-90% |
| Carbon black | 0-50% |
| Polystyrene | 0-20% |
| Ethylene-Propylene Copolymer | 0-40% |
| Ethylene Vinyl Acetate | 0-40% |
| Recycled Materials (e.g., eggshell, slag, asphalt shingles, | 0-90% |
| etc.) | |

Those skilled in the art will appreciate that the raw materials and corresponding formula percentage ranges are representative only. Accordingly, embodiments of the present invention embrace the addition of other raw materials and/or other percentage ranges (including, without limitation, sub-ranges of the ranges in Table 1), particularly for roofing asphalt, asphalt cement, caulking, and hot melt/hot glue adhesives, as well as sealants which contain fiber and aggregate or no asphalt at all.

In another non-limiting example, Table 2 provides representative weight percentage ranges of ingredients for inclusion into some embodiments of the described thermoplastic products:

TABLE 2

| | Weight % |
|---|---|
| Raw Material | Range |
| Asphalt Cement | 49%-77% |
| Light Oils | 0%-23% |
| Styrene butadiene Styrene block copolymers | 0%-6% |
| Styrene butadiene Rubber | 0%-4% |
| Polyolefins | 0%-3% |
| Ground Tire Rubber | 0%-22% |
| Ground Limestone | 0%-34% |
| Ground Talc | 0%-8% |
| Ground Sodium Bentonite | 0%-9% |
| Anti Strip Agents | 0%-1% |
| Plasticizers | 0%-1% |
| Electrically-Conductive material | 0%-70% |
| Ethylene-Propylene Copolymer | 0%-40% |
| Ethylene Vinyl Acetate | 0%-40% |
| Recycled Material (e.g., eggshell, asphalt shingles, | 0%-51% |
| slag, tar paper, asphalt pavement, ethylene | |
| polypropylene copolymer, etc.) | |

Those skilled in the art will appreciate that the raw materials and corresponding formula percentage ranges are representative only. Accordingly, embodiments of the present invention embrace the addition of other raw materials and/or other percentage ranges (including sub-ranges of the ranges in Table 2).

Before the thermoplastic product 20 is melted and used, it can have any suitable shape. In some embodiments, the thermoplastic product comprises an elongated shape (e.g., is shaped like a cord, a rope, a cable, a braid, a stick, a string, a ribbon, a bar, a brick, a slat, a cylinder, a pellet, a shape that allows the thermoplastic product to be linearly fed through a heater (as discussed below)), a block, a plug, a pellet, a bead, chips, flakes, chunks, powder, and/or any other suitable shape. For instance, FIGS. 1A-1E show some embodiments in which the thermoplastic product 20 resembles a rope or cord. In this regard, FIG. 2 shows an embodiment in which the thermoplastic product 20 is wrapped around a spool 25.

Where the thermoplastic product 20 comprises an elongated object (e.g., a cord, a rope, a braid, etc.), the product can have any suitable thickness or diameter. In some embodiments, however, the thermoplastic product has a thickness that is less than a width selected from about 13 cm, about 8 cm, about 3 cm, and about 1 cm. In some embodiments, the thermoplastic product has a thickness that is greater than a width selected from about 0.1 mm, about 1 cm, about 3 cm, and about 10 cm. In still other embodiments, the thermoplastic product has a thickness that falls in any combination and/or sub-range of the aforementioned ranges.

In some embodiments, another material is optionally placed adjacent to the thermoplastic product 20 (either before or during the melting process). In this regard, the additional material can be glued, melted to, bound to, coated on, melted with, braided with, twisted with, intertwined with, and/or otherwise placed adjacent to, mixed with, and/associated with the thermoplastic product during the melting process in any suitable manner. Moreover, any suitable material can be placed adjacent to and/or melted with the thermoplastic product. Some suitable examples of such materials include, without limitation, one or more other thermoplastic materials, additives, waxes, foams, adhesives, fillers, chemical reactants, tackifiers, UV protectants, hardening agents, a coloring agents, etc.

In some embodiments, the thermoplastic product 20 optionally comprises an outer layer. In such embodiments, the outer layer may perform one or more functions. In one example, the outer layer helps to prevent a portion of the un-melted thermoplastic product from sticking to another portion the product and/or another surface. In another example, the outer layer comprises an electrically-conductive material that helps melt the thermoplastic product as the product is passed through a heater (e.g., an inductive heater, as discussed below). In yet another example, the outer layer is used as a component of the thermoplastic product. Indeed, in some embodiments, the outer layer is configured to melt with, and become part of, the thermoplastic product.

While the outer layer can comprise any suitable material, in some embodiments, the outer layer comprises a material that is different (e.g., has a different chemical makeup and/or characteristics that vary) from the thermoplastic product 20 that is disposed within the outer layer. Some non-limiting examples of suitable coating materials include linear low-density polyethylene (e.g., a low-density polyethylene having a melt flow index between about 1 and about 5), a polymer (e.g., an expanded polymer, such as polystyrene; etc.), paper, tape, an ethylene-propylene copolymer, an ethylene vinyl acetate, a tackifier, a hardening agent, an adhesive, a foil (e.g., tin foil, etc.), a thermoplastic material having a different chemical makeup than the thermoplastic product disposed within the outer layer, a material comprising an electrically-conductive material, and/or any other suitable material that can be used to cover the thermoplastic product before it is melted. By way of illustration, FIG. 1A shows an embodiment in which the outer layer 30 comprises a linear low-density polyethylene. Additionally, FIG. 3 shows an embodiment in which the outer layer comprises a thermoplastic tape surrounding a thermoplastic material 22.

Where the thermoplastic product 20 is disposed within an outer layer 30, the thermoplastic product inside of the outer layer can have any suitable shape. Some examples of suitable shapes, include, without limitation, an elongated shape (e.g., being shaped as a solid rope (as shown in FIG. 3), cord, stick, etc.), a tube, a plurality of separate shapes (e.g., beads, pellets, chips, granules, etc.), or any other suitable shape. By way of non-limiting illustration, FIG. 4 shows a representative embodiment in which the thermoplastic product 20 comprises multiple beads 35 of thermoplastic material 22, which are disposed within the outer layer 30.

The described thermoplastic products 20 can be made in any suitable manner. Indeed, some examples of suitable methods include, but are not limited to, molding, extruding, mixing (e.g., premixing ingredients to form an un-melted thermoplastic and/or mixing ingredients at the time of melting the thermoplastic product), wrapping, braiding, joining (e.g., joining the thermoplastic product with another material, such as a curable adhesive), coating, spooling, packaging, heating, cooling, and/or otherwise forming the thermoplastic product.

Turning now to the systems and methods for heating the thermoplastic product 20, the thermoplastic product can be heated and/or melted in any suitable manner. Indeed, according to some embodiments, FIG. 5A shows the described heating system 40 is configured to force the thermoplastic product 20 (e.g., an elongated piece of the material) past one or more heaters 45 to melt the product. In such embodiments, the heating system can comprise any suitable mechanism that is capable of feeding one or more pieces (e.g., from one or more spools 25) of the thermoplastic product past the heater. Some examples of such feeding mechanisms include, without limitation, one or more feed wheels, feed dogs, augers, servomotors, motors, conveyor belts, pneumatic or hydraulic cylinders, access points that allow a user to manually force the thermoplastic product past the heater, etc. For instance, FIG. 5A shows an embodiment in which the heating system 40 comprises a pair of feed wheels 50 that are configured to force the thermoplastic product 20 towards the heater 45 to produce melted thermoplastic 55. Additionally, as the feeding mechanism can be used to dispense the melted thermoplastic product, FIG. 5A shows that, in some embodiments, the heating system 40 optionally does not include a pump for pumping melted thermoplastic product to a desired application surface.

While some embodiments of the heating system 40 comprise a single heater 45, other embodiments comprise multiple heaters (e.g., 2, 3, 4, 5, 6, or more). In such latter embodiments, the heating system may use the various heaters for any suitable purpose, including to incrementally heat the thermoplastic product.

The heating system 40 can also comprise any suitable type of heater 45, including, without limitation, an inductive heater, a heating element (e.g., one or more resistance wires, nichrome resistance materials, screen-printed metal-ceramic tracks deposited on ceramic insulated metal plates, etched foils, heat lamps, etc.), a conduction heater, an infrared radiation heater, a dielectric hysteresis heater, an electric arc heater, a plasma heater, a laser heater, a fire (e.g., fire applied directly to a container holding the thermoplastic product 20, fire used to heat a heat transfer fluid that heats a container holding the thermoplastic product, etc.), and/or any other suitable heater that is capable of heating the thermoplastic product to change the material to a liquid or semi-liquid state.

In some embodiments in which the thermoplastic product 20 comprises an electrically-conductive material 15 (e.g., iron, graphite, steel, slag, etc.), the heating system 40 optionally comprises one or more inductive heaters 60 (as shown in FIG. 5A). In such embodiments, the inductive heaters can comprise any suitable electromagnet (and/or other suitable inductive heater) through which alternating current (e.g., medium or high current) can be passed to create eddy currents (and/or to cause magnetic hysteresis losses) in the electrically-conductive material of the thermoplastic product to generate heat and melt the thermoplastic product. Some non-limiting examples of suitable inductive heaters or coils include conventional and novel voltage-source series resonant converter inductive heaters, and current-source parallel resonant converter heaters.

In some embodiments, the heating system 40 further comprises a guide for directing the thermoplastic product 20 through the heater 45. In such embodiments, the guide can comprise any suitable material and characteristic that allows it to perform its intended function. In some examples, the guide comprises a ceramic, glass, porcelain, plastic, and/or other material that is in the shape of a sleeve, groove, chute, guide, or other shape that is configured to guide the thermoplastic product through the heater. For instance, FIG. 5B shows an embodiment, in which the guide 65 comprises a porcelain sleeve 70.

Where the heating system 40 is configured to force the thermoplastic product 20 past the heater 45, the heating system can comprise any other suitable component or characteristic that allows it to function as intended. In some embodiments, the heating system comprises a reel, a catch, a spool, a sieve, a filter, and/or other mechanism that is configured to remove some if not all of the electrically-conductive material. For instance, some embodiments optionally comprise a compartment (not show) that is configured to collect wire from the thermoplastic product as it is heated. In other embodiments, the heating system 40 comprises a mixer (not shown) to mix the thermoplastic product and/or anything that is added to and/or melted with the thermoplastic product (e.g., the outer layer 30, a second thermoplastic material, an additive, etc.). In such embodiments, the heating system can comprise any suitable mixer that is capable of performing such a function.

In some embodiments, the heating system 40 comprises one or more controls (e.g., a switch to turn on the heater 45, a control to activate the feeding mechanism, a temperature setting control, etc.). Indeed, in some embodiments, the heating system comprises a switch in which a first engagement of the switch turns on the heater and a second engagement of the switch turns on the feed mechanism.

In some embodiments, the heating system 40 is also configured to vary the amount of heat produced by the heater 45 (e.g., inductive coil 60, heating element, etc.) in connection with the speed at which feeding mechanism operates. For instance, in some cases in which the heating system allows a user to melt and dispense the thermoplastic product at a variable speed, in order to allow the system to continue to melt the thermoplastic product at the higher speeds, the heating system increases the heat produced as the thermoplastic product is fed more quickly. In other cases, the speed of the feeding mechanism is varied to correspond to the temperature of the heater (e.g., as the heater heats up the speed of the feeding mechanism increases, and vice versa). While the heat produced by the heater can be varied to correspond to the speed of the feeding mechanism (and/or the speed of the feeder can be varied to correspond to the temperature of the heater) in any suitable manner, in some embodiments, the heating system comprises one or more potentiometers, thyristor power controls, autotransformers, and/or voltage regulators to perform such functions.

Where the heating system 40 forces the thermoplastic product 20 past the heater 45, the heating system can be placed in any suitable device, including, without limitation, in a thermoplastic-dispensing wand, a hot glue gun, a caulking gun, a cart, a trailer, and/or other unit that is capable of carrying one or more of the various components of the heating system. In this regard, FIG. 6 shows a representative and non-limiting embodiment of a wand 75 that comprises the heating system 40 (e.g., a feeding mechanism (namely feed wheels 50), a heater 45, a switch 46, a thermoplastic product 20, etc.).

The described heating system 40 can be powered in any suitable manner that is capable of providing enough heat to melt the thermoplastic product 20 and that is otherwise capable of allowing the heating system to function as intended. Indeed, in some embodiments, the heating system (e.g., the heater 45, such as an inductive heater 60, and/or feeding mechanism, such as a set of feed wheels 50) is powered by one or more fuel-burning generators (e.g., generators that burn diesel, biodiesel, gasoline, natural gas, hydrogen, etc.); generators that use a fuel cell that utilizes a separation technique where natural gas is separated into hydrogen, which is used in the fuel cell, and carbon, which is burned in the generator; generators that use a hydrogen fuel cell and oxygen; solar-panels; a socket connected to a power grid; etc.

The described systems, methods, and products can be varied in any suitable manner. Indeed, in some embodiments, the heating system 40 is configured to heat a reservoir of the thermoplastic product 20. While the heating system in such embodiments can have any suitable component and characteristic, FIG. 7 shows a representative embodiment in which the heating system 40 comprises a reservoir 80, an inductive surface 85 and one or more heaters 45 (e.g., inductive heaters 60). While the heaters in such embodiments can be disposed in any suitable location with respect to the reservoir (e.g., at or near a floor, covering, wall, and/or within the reservoir), FIG. 7 shows an embodiment in which the heater 45 (e.g., an inductive heater 60) is disposed at or near a floor 90 of the reservoir 80. In such embodiments, as power is supplied to the inductive heater 60, eddy currents form in the electrically-conductive inductive surface 85 (and/or the electrically-conductive material 15 (where present) in the thermoplastic material) to heat and melt the thermoplastic product 20. Additionally, FIG. 7 shows that, in some embodiments, the heating system 40 optionally includes one or more conventional pumps 95 and valves 100 (e.g., for recirculation and/or dispensing) that allows the heating system to be used with some conventional components (e.g., a conventional wand, not shown).

In other embodiments, FIG. 8 shows that, in some embodiments, the heating system 40 comprises an inductive heater 60, an induction surface 85 (e.g., a material comprising an electrically-conductive material), a reservoir 105 of a heat transfer substance (e.g., oil 110), and a container 115 for holding the thermoplastic product 20. While such embodiments can function in any suitable manner, in some instances, the inductive heater heats the induction surface 85, which heats the heat transfer substance (e.g., oil 110) that, in turn, heats the container 115 filled with the thermoplastic product 20 (i.e., a thermoplastic product with or without an electrically-conductive material 15).

In still other embodiments, FIG. 9 shows that in some implementations, a conventional system heated by fire 120 can be modified to include one or more inductive heaters 60. In some such embodiments, the inductive heater provides additional heat to the thermoplastic product 20 (e.g., via electrically-conductive material 15 in the heating system 40 and/or the thermoplastic product 20 and 125 (wherein 125 represents a solid block of the thermoplastic material)).

In yet other embodiments, FIG. 10 shows that in some instances, an inductive heater 60 interacts with electrically-conductive material 15 (not shown) in the thermoplastic product 20 to heat a reservoir 80 of the product 20.

In still other embodiments (which are not shown), the heating system 40 comprises an intensive kneader (e.g., an internal batch mixer, such as a BANBURY® mixer, a single rotor industrial mixer, a counter-rotating rotor industrial mixer, a tangential rotor type mixer, an intermeshing rotor type mixer, etc.) that is capable of using friction and/or pressure to melt the thermoplastic product 20. In such embodiments, melted thermoplastic product can be dispensed from the intensive kneader in any suitable manner, including, without limitation, through extrusion. Additionally, although in some embodiments, the thermoplastic product that is fed into the intensive kneader comprises the electrically-conductive material 15, in some other embodiments, such thermoplastic product is substantially, if not completely, free from the electrically-conductive material.

In addition to the aforementioned features, the described systems and methods may have one or more additional features. Indeed, in some embodiments in which the thermoplastic product 20 is melted as it is forced past a heater 45 (e.g., a thermoplastic product comprising an electrically-conductive material 15 is forced past an inductive coil 60), the described systems and methods are configured to melt a desired amount of the thermoplastic product, on demand. Accordingly, some such embodiments may result in less waste and require less energy than some conventional methods for melting thermoplastics. Additionally, some such embodiments may require little preparation time.

In another example, where the thermoplastic product 20 comprises a piece of elongated thermoplastic material that is heated on demand, the described systems and methods may result in less undesired splashing and associated burns than may be connected with some conventional methods in which a user drops a block of a thermoplastic into a vat of molten thermoplastic.

In another example, unlike some conventional methods that require a user to empty a vat before adding a second type of thermoplastic to the vat, some of the described embodiments (e.g., some embodiments in which the thermoplastic product 20 is fed past a heater 45 (such as an inductive heater 60)) allow a user to easily switch from one thermoplastic product to another (e.g., by feeding another thermoplastic product into the heating system 40).

In still another example, as some embodiments of the described systems and methods do not require a pump to dispense melted thermoplastic products 20, such embodiments allow the thermoplastic product to include one or more abrasive materials, such as ground glass, metal, hard stone, eggshells, incinerator ash, recycled materials, recycled asphalt shingles, recycled asphalt pavement, recycled concrete, slag from mineral refining, slag from iron and steel manufacturing, slag from iron and recycling, etc. Accordingly, in such embodiments, the thermoplastic product is able to include relatively inexpensive materials that would otherwise damage a conventional pump.

Thus, as discussed herein, embodiments of the present invention embrace thermoplastic products. In particular, the present invention relates to systems and methods for heating a thermoplastic product. In some non-limiting implementations, the described systems and methods use an inductive heater to heat the thermoplastic product. Indeed, in some non-limiting implementations, an elongated piece of thermoplastic product comprising an electrically-conductive material is moved past one or more inductive heaters to change the thermoplastic product to a liquid or semi-liquid state.

The present invention may be embodied in other specific forms without departing from its spirit or essential characteristics. The described embodiments and examples are to be considered in all respects only as illustrative and not as being restrictive in any manner. The scope of the invention is, therefore, indicated by the appended claims rather than by the foregoing description. All changes that come within the meaning and range of equivalency of the claims are to be embraced within their scope.

What is claimed is:

1. A system for heating a thermoplastic product, the system comprising:
a thermoplastic product comprising an electrically-conductive material;
a heater comprising an inductive heater; and
a mechanism for feeding the thermoplastic product past the inductive heater.

2. The system of claim 1, wherein the thermoplastic product comprises an elongated shape.

3. The system of claim 2, wherein the thermoplastic product comprises a rope-shaped object.

4. The system of claim 1, wherein the thermoplastic product comprises an outer layer that is configured to melt when the thermoplastic product is heated to a state selected from a liquid state and a semi-liquid state.

5. The system of claim 4, wherein the outer layer comprises at least one of: (i) a low-density polyethylene, (ii) an ethylene-propylene copolymer, (iii) an ethylene vinyl acetate, and (iv) a polystyrene.

6. The system of claim 1, wherein the system is configured to vary a level of heat produced by the inductive heater in accordance with the speed at which the feeding mechanism forces the thermoplastic product past the inductive heater.

7. The system of claim 1, wherein the thermoplastic product comprises a first material, and wherein a second material, which is different from the first material, is disposed adjacent to the first material, such that the two materials are configured to mix as the thermoplastic product is heated by the inductive heater.

8. The system of claim 1, wherein the system comprises a thermoplastic-dispensing wand.

9. The system of claim 8, wherein the system is capable of dispensing a melted form of the thermoplastic product via the wand without pumping the melted thermoplastic product through the wand.

10. A thermoplastic product, comprising:
a thermoplastic material; and
an electrically-conductive material,
wherein the electrically-conductive material is associated with thermoplastic material such that an inductive heater is able to melt the thermoplastic material by inductively heating the electrically-conductive material.

11. The product of claim 10, wherein the thermoplastic product comprises a sealant.

12. The product of claim 11, wherein the sealant is selected from a pavement joint sealant, a pavement crack sealant, an asphalt joint sealant, a concrete joint sealant, a bridge expansion joint sealant, a wide crack sealant, and a traffic loop detector sealant.

13. The product of claim 10, wherein the thermoplastic product comprises an elongated shape.

14. The product of claim 13, wherein the thermoplastic product comprises an outer layer having a different chemical makeup than the thermoplastic product and that is configured to melt with the thermoplastic product.

15. The product of claim 14, wherein the outer layer comprises at least one of: (i) a low-density polyethylene, (ii) an ethylene-propylene copolymer, (iii) an ethylene vinyl acetate, and (iv) a polystyrene.

16. The product of claim 10, wherein the thermoplastic product comprises at least one of ground glass, ground asphalt shingles, eggshells, and recycled asphalt pavement.

17. A thermoplastic product heating system, comprising:
a first heater comprising an inductive heater; and
a housing configured to hold a thermoplastic product,
wherein the inductive heater is capable of melting the thermoplastic product.

18. The heating system of claim 17, wherein the system further comprises a second heater that is different than the first heater.

19. The heating system of claim 17, wherein the system further comprises a feeding mechanism configured to force the thermoplastic product past the inductive heater.

20. The heating system of claim 17, further comprising a heat transfer fluid that transfers heat from the inductive heater to the thermoplastic product.

21. The heating system of claim 17, wherein the heating system comprises a thermoplastic-dispensing wand.
